(19) United States
(12) Patent Application Publication
(10) Pub. No.: US 2008/0020803 A1
(43) Pub. Date: Jan. 24, 2008

(54) METHODS AND DEVICES FOR RESTRICTING ACCESS TO MOBILE COMMUNICATION DEVICE FUNCTIONALITY

(75) Inventors: EDWARD RIOS, MC HENRY, IL (US); MICHAEL D. HARENG, LAKE IN THE HILLS, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/458,229

(22) Filed: Jul. 18, 2006

(51) Int. Cl. H04M 1/00

(52) U.S. Cl. 455/565

(57) ABSTRACT

Disclosed are methods and mobile communication devices having a plurality of functionalities in normal mode wherein at least one of the functionalities is limited in a restricted mode. In one embodiment a method includes the device receiving a signal to display a prompt to select from the plurality of functionalities to limit at least one of the functionalities while in the restricted mode. Selection of functions to limit or enable is described. The method further includes entering the restricted mode so that at least one of the plurality of functionalities is limited, and operating the device in the restricted mode. Restricted mode can include limiting access to the contacts list, the keypad functionality, games, voice calls, and the on/off switch. Also described is exiting restricted mode.

### FIELD

Disclosed are mobile communication devices and methods of a mobile communication device for restricting access to device functionality, and more particularly for limiting one or more functionalities of the device.

### BACKGROUND

The makers of mobile communication devices, including those of cellular telephones, are increasingly adding functionality to their devices. For example, cellular telephones include features such as gaming, still and video cameras, video streaming and two-way video calling, email functionality, Internet browsers, music players, FM radios with stereo audio, and organizers. Cellular telephones are evolving into powerful tools for information management.

Mobile commerce (m-commerce) is yet another functionality being incorporated into the operations of mobile communication devices. Mobile commerce, facilitated generally by mobile phones, can include services such as banking, payment, and ticketing. Accordingly, the emerging technology behind m-commerce may transform the mobile communication device into an electronic wallet.

Oftentimes, parents wish to give to their children mobile communication devices for emergencies and other reasons, albeit with fewer features than the above-described devices. Some makers of mobile communication devices market scaled down devices as dedicated children's telephones. However, a child may outgrow a dedicated child's phone as the child matures. A scaled down child's device may therefore not be useful in the long run.

Additionally, a child may prefer an adult mobile communication device to that of a scaled-down child's phone for reasons including aesthetics. In a dedicated child's mobile device, a keypad may support only a few functions. Oftentimes, a dedicated child's mobile communication device has a play toy appearance which may not appeal to older children. While a dedicated child's mobile communication device has the benefit of limiting the ability of a child to dial any telephone number from that mobile communication device, it may not be configured to be upgraded to a mobile communication device useful to an adult. Also, if an adult lends an adult mobile communication device to a child instead of giving the child a dedicated child's device, many or all of the above-described features are accessible to the child, even when such accessibility is not appropriate for the child.

### BRIEF DESCRIPTION OF THE DRAWINGS

FIG. 1 illustrates a mobile communication device configured to limit one or more functionalities selected from the plurality of functionalities of the device in a restricted mode according to an embodiment;

FIG. 2 is a flow chart illustrating an embodiment of a method of limiting functions and entering restricted mode as described herein;

FIGS. 3A and 3B combine into a table including a non-inclusive list of selectable profile attributes;

FIG. 4 is a flowchart diagram illustrating an embodiment for selecting features to limit or enable including those of default profiles;

FIG. 5 shows a mobile communication device according to an embodiment having a display screen and a keypad limited to softkeys;

FIG. 6 illustrates an embodiment for allowing access to an emergency contact list using a limited access keypad in restricted mode;

FIG. 7 illustrates steps of another embodiment for allowing access to an emergency contact list in restricted mode;

FIG. 8 is a flowchart illustrating a method for entering the restricted mode according to an embodiment; and

FIG. 9 is a flowchart illustrating a method for switching from the restricted mode to a normal mode according to an embodiment.

### DETAILED DESCRIPTION

It would be beneficial if an adult mobile communication device were configured to limit one or more functionalities selected from the plurality of functionalities of the device. Accordingly, an adult mobile communication device may emulate a dedicated child's mobile communication device. Depending upon the age of the child, the adult mobile communication device may be limited age appropriately by an adult user to varying degrees of functionality. Moreover, certain profiles, corresponding to one or more young users could be set up in advance of use so that the mobile communication device is ready for use by a youngster when the device is lent or given to the child by an adult. In this way, a simplified user interface with the abridged feature set that runs on top of an existing device user interface may make it easier for a youngster to use the mobile communication device, for example, in an emergency.

Disclosed are methods and mobile communication devices having a plurality of functionalities in normal mode wherein at least one of the functionalities is limited in a restricted mode. Normal mode allows wireless communication to be bounded only by the capabilities of the device and/or service provided by its connected network. Restricted mode restricts a wireless communication device to only communicate with a smaller subset of destinations and may further restrict functionality of the device.

In one embodiment a method includes the device receiving a signal to display a prompt to select from the plurality of functionalities to limit at least one of the functionalities while in the restricted mode. The method further includes entering the restricted mode so that at least one of the plurality of functionalities is limited, and operating the device in the restricted mode. As will be described in detail below, various functions and combinations of functions can be limited depending upon the intended user and purpose. For example, in one embodiment, while in restricted mode, unnecessary keys such as the “Smart Key” can be disabled so the user, such as a child, may be kept from exiting the restricted mode. In another embodiment, a restricted mode is a game mode where only games have been enabled. In game mode pressing the End/Send keys may not abruptly halt execution of the game as a mobile device in normal mode does. Furthermore, the user interface may be designed such that pressing the End key will result in switching from restricted games to restricted voice, but may not result in exiting the restricted mode. It is understood, that the combination of selected features for restricted mode may be treated in a variety of manners, and the discussion herein is not intended to limit the large number of selection combinations possible.

Mobile communication devices are often programmed with an emergency contact list including emergency providers such as fire departments, ambulance service and police departments. For example, an emergency contact list can be installed into a device's memory upon activation or downloaded upon SIM installation. Generally, the emergency list is a non-editable contact list. In one embodiment, disclosed is a method of a mobile communication device having a contact list having a plurality of contacts and a non-editable contact list. The method includes entering the restricted mode which includes limited access to the contact list and/or access limited to a non-editable contact list.

In another embodiment, disclosed is a method of a mobile communication device having a keypad wherein entering the restricted mode includes limited access to the keypad so as to permit access to capabilities and functions of predetermined soft keys. The soft keys may provide access to the limited contacts list as is discussed below.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

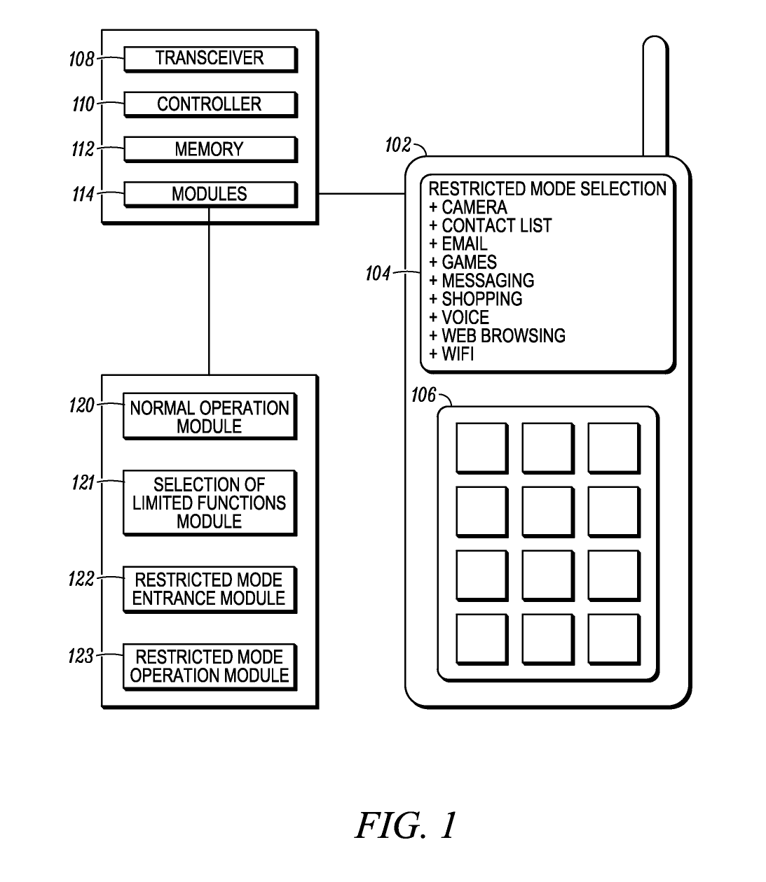

FIG. 1 illustrates a mobile communication device configured to limit one or more functionalities selected from the plurality of functionalities of the device in a restricted mode according to an embodiment. The handset 102 depicted in FIG. 1 is a mobile communication device. It is understood that any mobile communication device is within the scope of this discussion. The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The mobile communication device 102 can include at least one display screen 104 and a keypad 106. Additionally, the device 102 can include a transceiver 108, a controller 110, memory 112 and modules 114. The modules include a normal operation module 120, a selection of limited functions module 121, a restricted mode entrance module 122, and a restricted mode operation module 123. The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

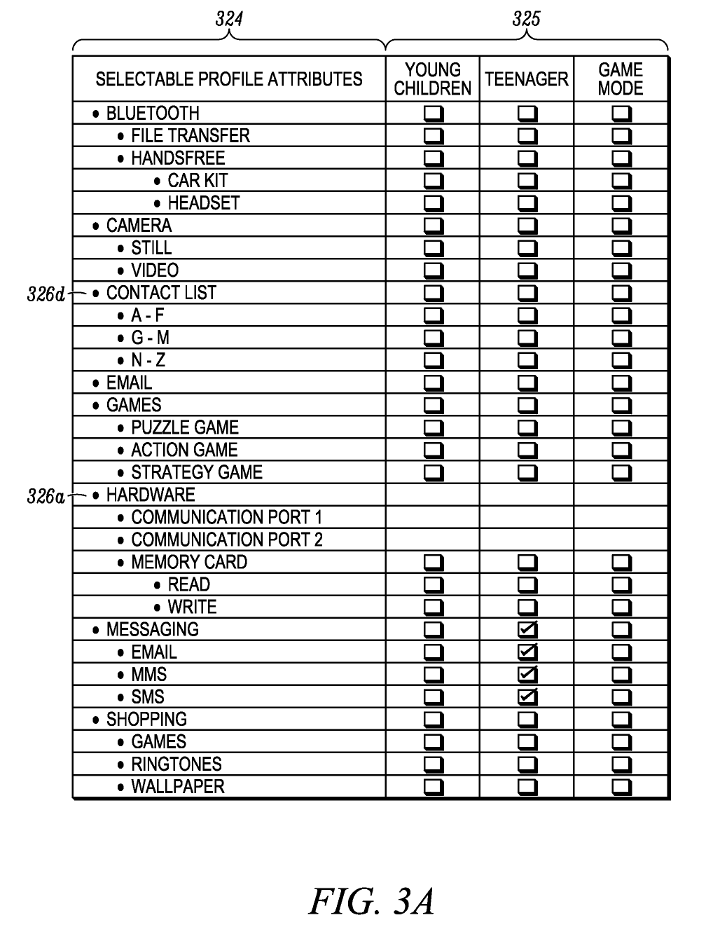

As mentioned above, a mobile communication device 102 can have a plurality of functionalities in normal mode. The display screen 104 lists various functionalities in what is called a flat-list. The flat-list may be further categorized as is shown in FIGS. 3A and 3B discussed below. In a normal mode, the device may include some or all of the available function options. To prepare the device for restricted mode, a prompt may be provided on the display screen from which the user can select which functionalities to limit while the device operates in restricted mode. In the alternative, the prompt may provide which of the functionalities to allow in the restricted mode.

When operating the device in normal mode, a user may select a functionality of the device according to a prompt to limit at least one of the functionalities while the device operates in a restricted mode. It is understood that the prompt may be in any form, including an audio prompt. It is further understood that the functionalities listed for restricted mode selection may be arranged in any manner, and may include or not include all categories of functionalities and their subcategories. The flat-list and categorized list may be populated according to a default age group and/or may be populated according to user preferences.

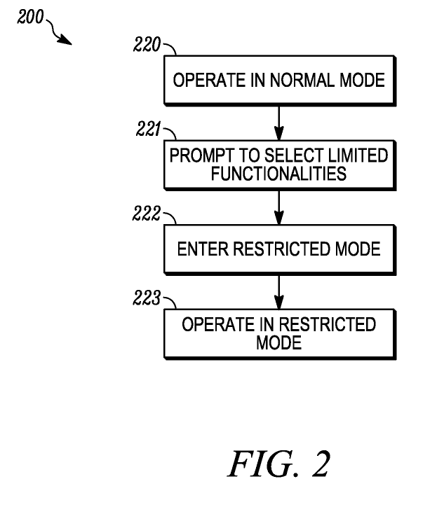

FIG. 2 is a flow chart illustrating an embodiment of a method 200. Initially the device may operate in a normal mode 220. Normal mode may include operable functionalities and inoperable functionalities according to normal operation module 120 (see FIG. 1). Normal mode may of course be customized by the user. A user may access a prompt to limit functionalities for restricted mode 221 according to selection of limited functions module 121. Looked at in another manner, in making a selection the device may be considered disabled, and features selected for the restricted mode are therefore enabled. In any event, as illustrated in FIG. 1, the first list that the user views on the display is a list of categories. By selecting a category, a list of subcategories may be provided. A user may signal when the selection is complete and then may enter into the restricted mode so that at least one of the plurality of functionalities is limited and/or enabled 222 by receiving a signal to enter a restricted mode according to the restriction mode entrance module 122. The device may then operate in a restricted mode 223 according to the restricted mode operation module 123.

FIGS. 3A and 3B combine into a table including a non-inclusive list of selectable profile attributes. On the left side 324 under “Selectable Profile Attributes” are categories and subcategories. On the right side 325 are general user profiles including young children, teenagers and game mode. It is understood that FIGS. 3A and 3B are by way of example and that functionalities and profiles may be dependent upon those of the device or any other factors including user preference. The categories may be listed in any manner. The user profiles may be listed in any manner. While the profiles are shown as general user profiles, they may of course be personalized or customized to specific users, for example for Susie, Mickey, and Joey. Additionally, the emulated child's mobile communication device may also suggest selections to make depending upon age group as a prompt. For example, set of user profiles may be children ages 6-8, 9-11 and 12-14. Default settings for age groups may be provided. There can be a prompt for an age group, and a user may select the age group. If the adult wishes to learn more about a feature, a help menu describing the age appropriateness of a feature may be included in the selection process.

The lists of FIGS. 3A and 3B can include selections for features such as hardware components 326a such as communication ports, and features for preventing children from circumventing the restricted mode 326b by controlling the on/off functions of the device. Additionally, profile information 326c can be selected and can include custom ringtones and backgrounds. For example, an adult may use a classical piece for a ringtone, whereas the adult may chose for the child a children's song for the ringtone. For the background, an adult may use a photograph of their spouse and children, but the adult may select for the child a photograph of the child's mother for the background.

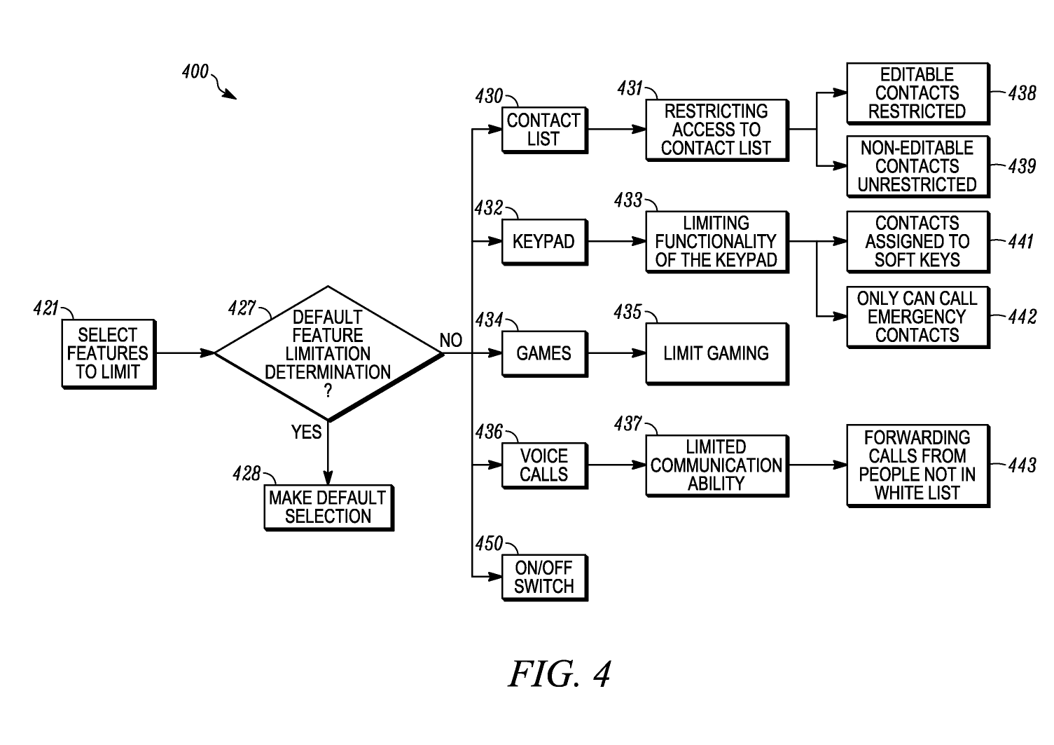

The contact list 326d may be limited by selecting the contact list from the selectable profile attributes 324. Once a limited access contact list is formed, the list may be stored as part of a user profile 325. A contact list, including a limited access contact list, may be referred to herein as a telephone book, a phone book, or an address book. The user interface for forming the limited access contact list may be designed in any manner. In one embodiment, as illustrated on FIG. 3A, letters of the alphabet are grouped so that the user may make a selection according to the first, last or nicknames of the contacts. By prompt the user may select contacts to customized a contact list and store the limited access contact list so that it is available during restricted mode according to one or more user profiles. To form a limited access contact list, a user during selection can select which contact of the contact list to include in a limited access contact list. For example, a user may wish to choose “Mom” 560 and “Dad” 561 (see FIG. 5) for a limited access contact list according to a particular user profile such as young children 325.

In another embodiment, the selected contact list may be limited according to predictive analysis. For example, words such as “Grandma” and “Dad's Cell” may be presented to the user for confirmation and then if the confirmation is positive, the contact is added to the limited contact list. It is understood that the contact list may be limited in any manner.

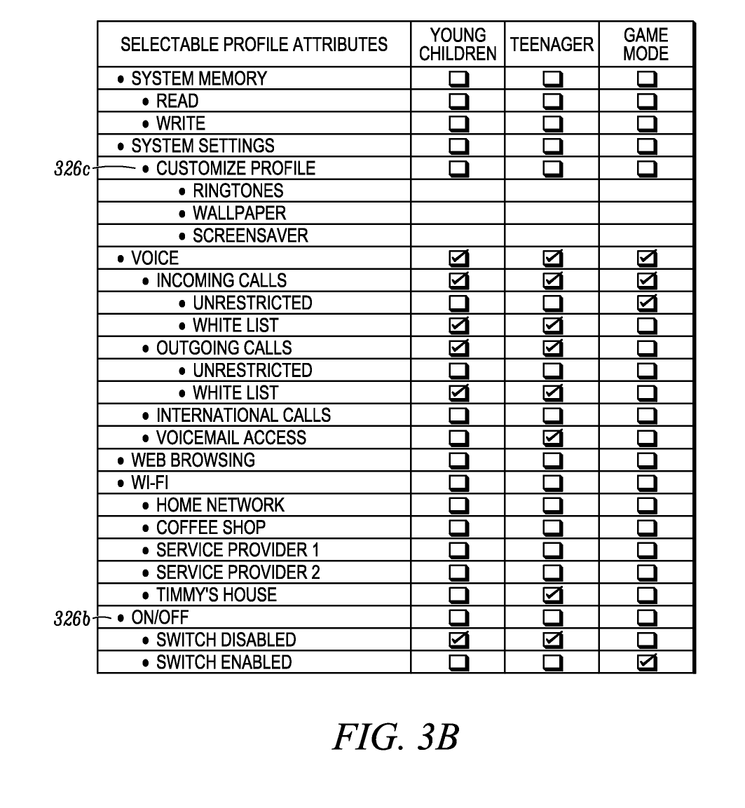

FIG. 4 is a flowchart diagram 400 illustrating an embodiment for selecting features to limit or enable. FIG. 4 includes step 421 similar to step 221 shown in FIG. 2. Restrictions can be selected in many different manners. In one embodiment, a determination of whether to use one or more default feature limitations is queried 427. Default limitations were discussed above with reference to FIGS. 3A and 3B. If yes, the default selection is made 428. If no, selected features may include a contact list such as a telephone book 430, keypad access 432, game access 434, voice call access 436 and an on/off switch 450. As discussed above, it is understood that the listed features are a non-exclusive list.

When the device is in the restricted mode, the limited or restricted contact list 431 may be directly indicated on the display. Briefly referring to FIG. 5 a mobile communication device 502 having a display screen 504 and a keypad 506 is shown. The display screen can display enabled contacts “Mom” 560 and “Dad” 561 in a format which a soft key 562 and soft key 563 can activate. The enabled telephone book 564 may include other contacts which can be presented in the same manner as “Mom” and “Dad” or as a menu that, for example, may be navigable by navigation keys 565. It is understood that the contact list can be limited or abridged in any manner, such being referred to as a “white list.”

Still referring to FIG. 5, the user interface of the device from normal mode to restricted mode may change. In restricted mode, the display content may change for example, by using bigger fonts and less information than in normal mode. The user interface shown on display screen 504 shows an embodiment where there are three options provided in this restricted mode: call Mom, call Dad, or browse the address book, which may be limited to, for example, one or more emergency numbers. Accordingly, the Mom 460 and Dad 461 telephone numbers can be dialed by pressing the corresponding soft key, 462 and 463 respectively, without having to go into the telephone book.

An adult user may not only wish to limit the contact list, but also depending upon the age group of the youngster, the adult user may wish to limit changes for example, to any settings and changes to the contact list. On the other hand, if the youngster, for example, is a teenager, the youngster may be allowed to add names to the contact list or change settings as it relates to that particular user's profile. In adding contacts, there may be filters employing certain criteria such as particular contacts or those outside, for example, a particular area code. The added names and/or changed settings may be accessible when the device is in a restricted mode according to a user profile.

As mentioned above, mobile communication devices are often programmed with an emergency contact list including emergency providers such as fire departments, ambulance service and police departments. For example, an emergency contact list can be installed into a device's memory 112 (see FIG. 1) upon activation or downloaded upon SIM installation. Generally, the emergency list can be a non-editable contact list.

Again referring to FIG. 4, the manner in which the editable contact list 438 such as the telephone book of the device and a non-editable contact list 439 such as emergency numbers are accessed in the restricted mode may vary dependent of preference or practicality factors. In one embodiment, the keypad 106 (see FIG. 1) could be completely disabled in restricted mode except for use in initiating communication with “911.” In another embodiment the contact list restriction 431 can be affected so that there is no difference between initiating communication with, for example, “911” and an allowed contact.

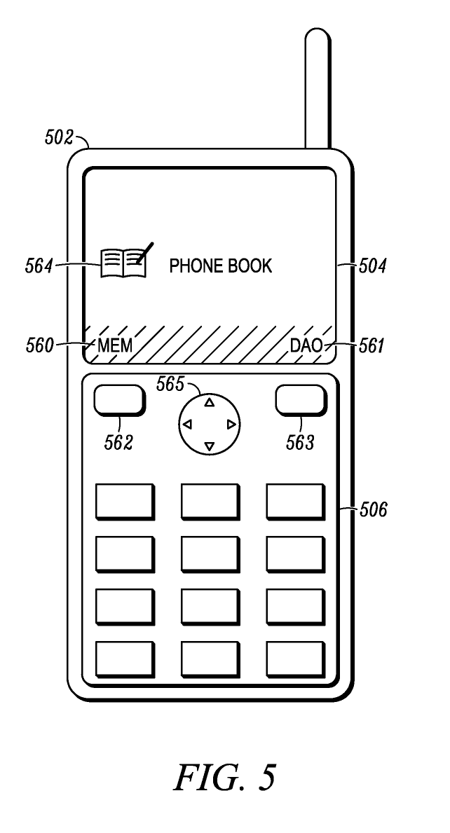

Depending upon the types of function limitations selected, the keypad can be selected 432 accordingly. In one embodiment, limiting the functionality of the keypad 433 may include, for example, assigning contacts to soft keys 441 as described with reference to FIG. 5 above. In another embodiment, limiting the functionality of the keypad may include allowing keystrokes for only emergency contacts 442 as described with reference to FIG. 6 below.

Again referring to FIG. 5, in a situation, for example, where the display screen shows “Mom” and “Dad” accessible by soft keys 562 and 563, a child may know, in an emergency situation, to access a phone book 564 as described above. The child, though, may know that an emergency number is “911.” The child may therefore be inclined to input key presses of “911” onto the keypad. In any event, an emergency contact may be accessible via the soft key, by access to a menu that may be navigable, or via a limited keypad.

FIG. 6 illustrates another embodiment for allowing access to an emergency contact list using a limited access keypad in restricted mode. The device can be activated 670 and the key presses can be received when the user types one or more characters 671. The number of characters may be three, as in the key presses needed to access emergency services via “911.” The method can include determining if there have been three key presses 672. If yes, there can be a determination whether the number associated with the key presses corresponds to an emergency number, for example, stored in an emergency lookup table 673. In the United States, emergency services can be accessed 669 by dialing “911,” and in Europe, “112.” If the string of three numbers input into the keypad is found in the emergency lookup table, the send key can be enabled 674 and the call initiated 675. On the other hand, a child may know the telephone numbers of the contacts in the allowed contact list. The limited keypad may allow the child user to dial emergency numbers and allowed contacts. Accordingly, there can be a determination whether there are more or less than three characters 672. Then there can be a determination whether the number is in an allowed contact table 676 for example, to “Mom,” “Dad,” or “Grandma” 677. If yes, then the send key can be enabled 678 and call initiated 679. It is understood that any manner in which to display and access the enabled editable contact list and non-editable contact list is within the scope of this discussion.

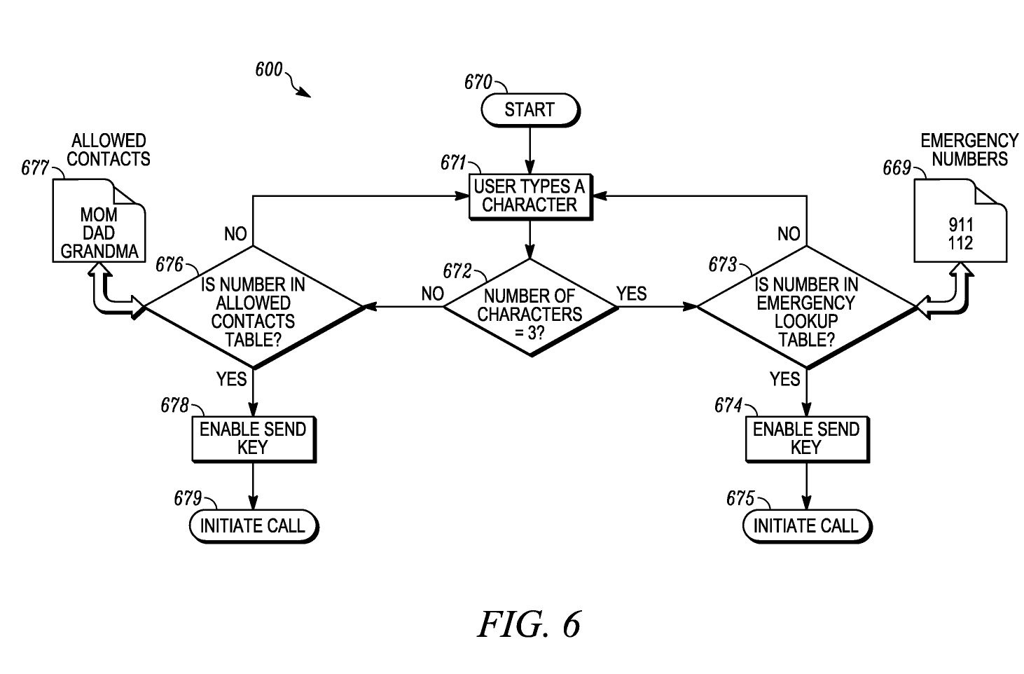

Referring to FIG. 7, in another emergency contact list embodiment, entering the restricted mode can include limited access to the contact list or can include access limited to a non-editable contact list when the contact list has not been limited. When entering restricted mode 780 a determination can be made whether the editable contact list has been limited 781. If not, access to a non-editable contact list, such as an emergency contact list is permitted 782. In this manner, in restricted mode, the device can only initiate communication with contacts on the non-editable contact list 442 (see FIG. 4). If yes, then the limited contact list is activated 783 and optionally, the non-editable contact list can be activated in restricted mode as well.

Again referring to FIG. 4, displaying a prompt to select from the plurality of functionalities to limit at least one of the functionalities while in a restricted mode may include the gaming function 434. Gaming, in particular, can consume power of the device. In the event that a user is concerned, for example, with reducing energy consumption, the gaming may be limited, either entirely or partially, or with respect to time spent or at what time or times of the day gaming would be allowed. It is understood that limiting gaming 435 may take into consideration any preference and practicality factors.

In another embodiment, it may be beneficial to limit only the gaming function 434. Referring to FIG. 3a and 3b, on the right side there is a column dedicated to the game mode. There may be times when an adult wishes to provide a gaming device to a youngster and thus may enable only the games. When game mode is selected, then a prompt may include a selection of games. The keypad may become a game-playing dedicated keypad. The send and end keys of the keypad may be disabled.

The games enabled may be identified by their age appropriateness as well. In this manner a shortcut to the selection of games may provide easy access to the games when needed. Incoming calls can be processed in a normal manner or can be forwarded or diverted when the device is in game mode.

The game mode or other limited configuration can be unlocked by providing authorization to unlock. Such authorization may be effected by an adult. In one embodiment, the game mode or other limited configuration may be the default user interface setting for powering up the device. Thus any restricted mode may not be disabled by removing the battery and replacing the battery. If the battery is removed, the mobile communication device may not revert to normal mode on power-up. The power-up procedure can include a check on a memory location to determine whether to load normal or restricted mode. Entering and exiting the restricted mode is discussed in more detail below.

Again referring to FIG. 4, displaying a prompt to select from the plurality of functionalities to limit at least one of the functionalities while in a restricted mode may include incoming communication 436 such as voice calls. As discussed above, the contact list can be limited, such being referred to as a “white list.” As outgoing communication associated with the contacts can be limited, incoming communication can be limited 437 as well. The outgoing communication can be in the form of voice calls, but can also include messaging, web browsing including shopping, banking and other communication processes. In one embodiment, an incoming call can be received by the device if the caller identification is allowed by the limited contact list. Incoming calls from those parties not on the limited call list and/or not on the contact list at all, for example, may be forwarded to another number or a messaging service 443. Alternatively, incoming calls may be allowed to ring through normally. In the event that a user is in game mode, the game can be paused and restarted on call completion or other options can be selected. A list of blocked calls may be kept in memory 112 (see FIG. 1) of the device for future reference.

Certain mobile communication devices may be equipped with a GPS service for global positioning. In such a case, it may be beneficial, for example to a parent, that the device is always on when it is used by a child. Also, if the device is always on, incoming calls from contacts on the selected contact list can be received or diverted as discussed above. Thus, provided the device and the child are not separated, the device can be used to locate the child. In another embodiment, displaying a prompt to select from the plurality of functionalities to limit at least one of the functionalities while in a restricted mode may include limiting the ability to turn the device on and off under various conditions 450.

To make a selection from a plurality of functionalities to limit at least one of the functionalities while in a restricted mode may be initiated in any manner. In the event that the feature selection process (see FIG. 4) from the selectable profile attributes 324 (see FIG. 3A) is protected, it is understood that various protection mechanisms can be employed. For example, to make the selections, a PIN code or other authorization may be entered to access a list of selectable profile features such as those provided in FIGS. 3A and 3B. Once one or more features has been limited, the device can receive a command to enter into restricted mode 222 (see FIG. 2).

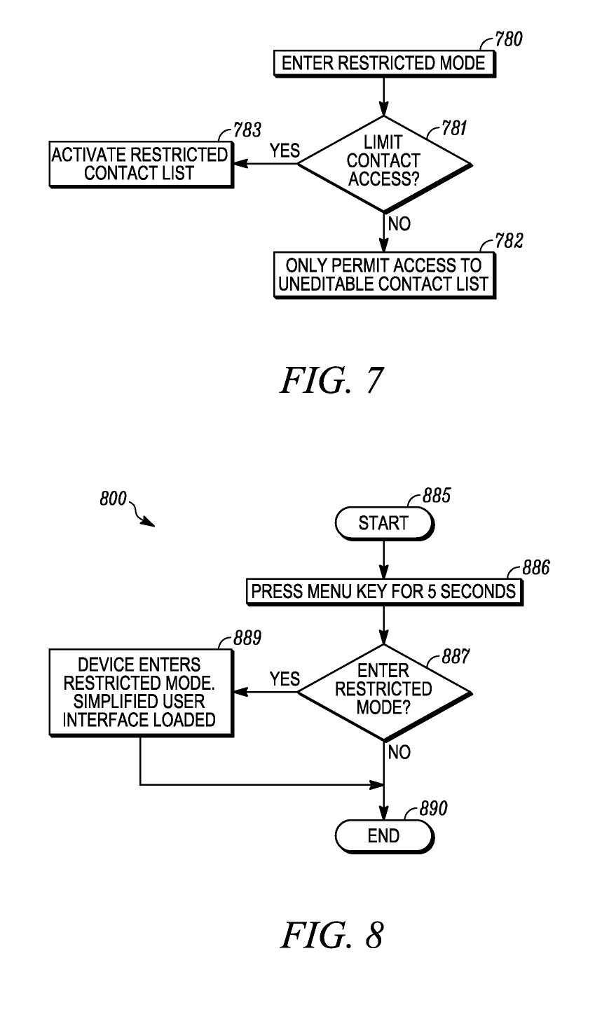

Referring to FIG. 8, a flowchart illustrates according to an embodiment a method 800 for entering the restricted mode 222 (see FIG. 2). That is, after one or more selections are made during the feature selection process (see FIG. 4) entering into the restricted mode can be effected. In one embodiment, entering the restricted mode may be initiated 885 by holding down a key 886 of the keypad 106 (see FIG. 1) such as a menu key for a predetermined period of time, such as five seconds. The device may provide a prompt 887 to the user to confirm whether to proceed in the restricted mode. If yes, in this embodiment, the mobile communication device can enter the restricted mode so that a simplified user interface is loaded 889. If no, the process can end 890. The user can select yes or no from the left or right soft keys.

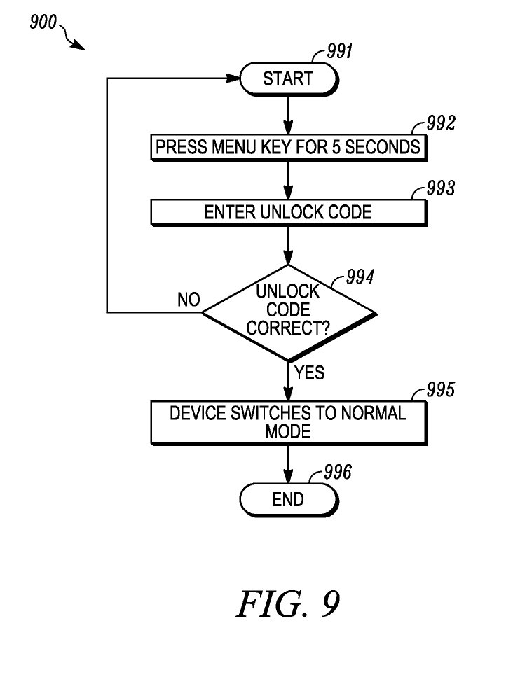

FIG. 9 is a flowchart illustrating a method 900 for switching from the restricted mode to a normal mode according to an embodiment. The process may be initiated 991 by holding down a key 992 of the keypad 106 (see FIG. 1) such as a menu key for a predetermined period of time, such as five seconds. For security, exiting the restricted mode may require an unlock code such as a PIN code or other authorization that may be entered 993. In other embodiments, switching from restricted mode to normal mode may be effected with key presses of a combination of multiple keys, voice recognition, finger print or any other manner of identification. A determination as to whether the correct sequence is entered 994 can be made. If no, then the process may be initiated 991 again. If yes, the device can switch to normal mode 995 and end 996 the switching process. It is understood that any process by which to enter and exit restricted mode of the device is within the scope of this discussion.

As discussed above, an adult may lend or give a mobile communication device having a plurality of features to a child or other person. Described above are methods and devices for emulating a dedicated child's mobile device by a fully functional mobile communication device. Many options are available for selecting functions to limit and enable including dedicated soft keys for Mom, Dad and an emergency, a locked keypad except for 911, and using soft keys to dial numbers from an abbreviated contact list. Incoming communication can be unfiltered or filtered. Various profiles can be available by default or may be customized so the device may be used by multiple users of different ages. Some profiles may have locked access to features and hardware. Moving between profiles may be by menu or key activation. Security in maintaining a restricted mode can be activated by a lock/unlock code. Accordingly, when an adult lends an adult mobile communication device to a child, or to another adult where the first adult may wish to keep certain information or functions private or otherwise inaccessible, many or all of the above-described features and additional features not above-described may have limited accessibility, since such accessibility may not be appropriate.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method of a mobile communication device having a plurality of functionalities in normal mode, the method comprising:
operating the device in a normal mode;
displaying a prompt to select from the plurality of functionalities to limit at least one of the functionalities while in a restricted mode;
receiving a signal to enter a restricted mode;
entering the restricted mode so that at least one of the plurality of functionalities is limited; and
operating the device in the restricted mode.

2. The method of claim 1 wherein operating in normal mode comprises the ability to access a contact list, the method further comprising:
receiving a response to the prompt to limit access to the contact list.

3. The method of claim 1 wherein operating in normal mode comprises a keypad capability, the method further comprising:
receiving a response to the prompt for limiting the keypad capability.

4. The method of claim 3 wherein limiting the keypad capability comprises:
permitting access to communication to at least one emergency contact.

5. The method of claim 3 wherein limiting the keypad capability comprises:
permitting access to capabilities and functions of predetermined soft keys.

6. The method of claim 1 wherein operating in normal mode comprises gaming capability, the method further comprising:
receiving a response to the prompt to limit gaming capability.

7. The method of claim 1 wherein operating in normal mode comprises communication capability, the method further comprising:
receiving a response to the prompt for limiting communication capability.

8. The method of claim 7 wherein operating in restricted mode comprises limited access to a contact list wherein limiting communication capability comprises:
forwarding communication from callers not on the limited access contact list.

9. The method of claim 1 wherein the mobile communication device has a keypad and wherein receiving a signal to enter a restricted mode comprises:
activating a particular key of the keypad for a predetermined period of time.

10. The method of claim 1, further comprising:
receiving a signal to deactivate the restricted mode; and
restoring the device to normal mode.

11. The method of claim 10, wherein receiving a signal to deactivate the restricted mode comprises:
receiving identifying input.

12. The method of claim 11 wherein the identifying input is a PIN code.

13. The method of claim 1 wherein operating in normal mode comprises on and off states capability, the method further comprising:
receiving a response to the prompt for limiting the off state capability.

14. A method of a mobile communication device having a contact list having a plurality of contacts, the method comprising:
operating the device in a normal mode;
receiving a signal to enter a restricted mode;
entering the restricted mode which includes limited access to the contact list; and
operating the device in the restricted mode.

15. The method of claim 14 further comprising:
receiving identifying input to generate the prompt to select from the plurality of functionalities to limit at least one of the functionalities while in a restricted mode.

16. The method of claim 14 wherein operating in the restricted mode includes access to a non-editable contact list as well as the limited access contact list.

17. The method of claim 14 further comprising:
displaying a prompt to the user to select at least one of the plurality of contacts from the limited access contact list in the restricted mode.

18. A method of a mobile communication device having a non-editable contact list, the method comprising:
operating the device in a normal mode;
receiving a signal to enter a restricted mode;
entering the restricted mode which includes access limited to the non-editable contact list; and
operating the device in the restricted mode.

19. The method of claim 18 further comprising:
receiving identifying input to generate the prompt to select from the plurality of functionalities to limit at least one of the functionalities while in a restricted mode.

20. The method of claim 18 wherein operating in the restricted mode includes access to a limited access contact list as well as the non-editable contact list.

21. The method of claim 18 further comprising:
displaying a prompt to the user to select at least one of a plurality of contacts from the non-editable contact list in the restricted mode.

22. A method of a mobile communication device having a keypad, the method comprising:
operating the device in a normal mode;
receiving a signal to enter a restricted mode;
entering the restricted mode which includes limited access to the keypad so as to permit access to capabilities and functions of predetermined soft keys to form limited keypad capability; and
operating the device in the restricted mode.

23. A method as recited in claim 18 wherein entering the restricted mode further includes limiting access to a contact list of the device to form a limited contact list.

24. A method as recited in claim 18 wherein the limited contact list is accessed by the predetermined soft keys.
